(19) United States
(12) Patent Application Publication
(10) Pub. No.: US 2006/0108140 A1
(43) Pub. Date: May 25, 2006

(54) Automatic gel splice

(75) Inventor: Kevin R. Wiley, Bethlehem, GA (US)

Correspondence Address: TROUTMAN SANDERS LLP, 600 PEACHTREE STREET , NE, ATLANTA, GA, 30308, US

(73) Assignee: The Southern Company, Atlanta, GA (US)

(21) Appl. No.: 11/282,492

(22) Filed: Nov. 18, 2005

Related U.S. Application Data
(60) Provisional application No. 60/631,067, filed on Nov. 24, 2004.

(51) Int. Cl. H01R 4/00

(52) U.S. Cl. 174/84 R; 174/88 R

(57) ABSTRACT

An improved automatic gel splice is described. The automatic splice can include a tapered cylindrical body having end funnels positioned at opposite ends. Within the end funnels, a gel is positioned to protect the splice from potential contaminants. The gel can be a semi-conductive, waterproof gel. The gel acts with positioned finger joints within the splice to seal the interior of the splice.

### CROSS REFERENCE TO RELATED APPLICATIONS

This application claims the benefit, under 35 U.S.C. § 119, of U.S. Provisional Application Ser. No. 60/631,067, filed 24 Nov. 2004.

### BACKGROUND OF THE INVENTION

1. Field of the Invention

The present invention generally relates to automatic splices, and more specifically to the use of waterproof gel at each end of an automatic splice of an electric utility line to prevent moisture and contaminants from entering the splice body to prevent internal corrosion.

2. Description of the Related Art

Automatic splices are used to longitudinally splice two lengths of cable together. Such devices are typically used by power utility linemen to splice lengths of high voltage cable together.

Automatic splices are a commonly-used connector for bare overhead electric utility lines, for example. B. C. Hydro found a problem with automatic splices that were installed in lines exposed to corrosive environments, for instance, salty seacoasts and heavy industrial areas. The study of this problem was outlined in an article in Transmission and Distribution World, March 2004, written by Fred Kaempffer. This study found that contaminants were entering the splice body, and over time, the internal components of the splice would corrode, causing eventual failure of the splice.

Splice art references are typified in U.S. Pat. Nos. 2,906,810, 3,842,191, 4,157,208, 4,832,767, 5,574,257, and 6,220,893. Yet each reference includes disadvantages and limitations overcome by the present invention.

For example, U.S. Pat. No. 2,906,810 to D'Ascoli relates to the splicing of insulated electric conductors. It is understood by those of skill in the art that insulated electric conductors are distinguishable from bare electric conductors. Further, D'Ascoli discloses a cylindrical capsule having one end closed and the other end open, and that splices can be covered with suitable insulating material, such as a wrapping of friction tape. Also, D'Ascoli discloses the use of cylindrical plastic collars to secure a cylindrical tube of an insulating plastic, wherein the collars are made of mating half cylinders bolted or otherwise suitably secured together.

U.S. Pat. No. 3,842,191 to Neale, Sr. relates to a device for splicing insulated wires such as drop wires. The splice accommodates a two conductor splice. The Neale, Sr. device comprises a contact member that has a plurality of teeth that penetrate the insulation and engage conductors in the wires being spliced. Neale, Sr. further discloses that the splicing device wraps cable around an end of the contact member in a U-shape.

U.S. Pat. No. 4,157,208 to Roberts et al. discloses the use of a rotatable inner insulating plug member with a generally flat metallic plate-like wire terminating member. As the outer casing is rotated relative to the plug member, the plate-like member rotates. Further, Roberts et al. discloses splicing a plurality of wires, and using connectors that are needed in various applications, for example, in the termination of telecommunications cables in adverse environments.

U.S. Pat. No. 4,832,767 to Eller discloses an apparatus for wrapping a bundle of wires spliced together using self-welding or autogenous tape.

U.S. Pat. No. 5,574,257 to Brauer et al. discloses the protection of telecommunications terminal blocks and the like with enclosures filled with gelled oil, and uses a two piece enclosure which comprises a top and a base.

U.S. Pat. No. 6,220,893 to Stephan discloses splices for severed electrical wires, especially in hand-held appliance tools, such as drills, sanders, saws, and the like. Stephan further discloses a splice connector including a top cover connected to a lower section, by a hinge or by at least one fastener, and uses clamps that may be of metal or other non-metallic plastic composition of suitable durability and strength, which are held by fasteners, such as screws, to molded clamp towers. Stephan also discloses using terminal blocks with imbedded conductive plates using screws to restore electrical continuity between proximal end and distal end of the severed line cord.

Therefore, it can be seen that a need yet exists for an automatic gel splice device for limiting the amount of contaminants entering the interior of the device. It is to such a device and method that the present invention is primarily directed.

### BRIEF SUMMARY OF THE INVENTION

The present invention is an apparatus for, and method of, splicing overhead wires that incorporates a waterproof gel at each end of an automatic splice to prevent moisture and contaminants from entering the splice body to limit internal corrosion. The invention solves a current problem in the splice art, where conventional automatic splices that are used on bare overhead conductors have shown to deteriorate when exposed to corrosive environments, such as salty seacoasts and heavy industrial areas.

The present invention combines a sealed gel port design with an end funnel design of an automatic splice. By using a high temperature semi-conductive gel sealant inside of extended end funnels, the internal components of an automatic splice are protected from the deteriorating contaminants that are present in corrosive environments. These improvements reduce the likelihood of failure of automatic splices in corrosive environments, thus improving system reliability and increasing public safety.

In some respects, the present invention includes the best of splices used commonly for overhead conductors, and underground submersible connectors, combining the filled gel port part of underground submersible connectors with an automatic splice. With modification to the end cap or end funnels, the gel material stays within the splice. The gel material is used to prevent contaminants from entering the splice body, the cause of internal corrosion.

This present device and method is mainly for a utility, which can be used for low, medium or high voltage lines, versus what conventional splice designs are used for—telecom or just low voltage insulated wires, versus utility, non-insulated or bare wires.

In a preferred embodiment of the present invention, an automatic splice for connecting two conductors is described. The automatic splice includes a splice body having a center stop enabling proper conductor insertion depth. The splice body includes two opposite ends. The automatic splice further includes a spring-loaded jaw located at opposite ends of the splice body, an end funnel located at opposite ends of the splice body enabling insertion of the conductor into the splice body, and a gel housed in the end funnel to protect the automatic splice from deteriorating contaminants.

Moreover, the splice body of the automatic splice can have a tapered cylindrical shape. The end funnel can include a plurality of first finger joints to hold the gel in the end funnel. The end funnel and the finger joints can be of unitary construction. The splice body of the automatic splice can include a plurality of second finger joints. Also, the gel of the automatic splice can be a waterproof gel to prevent moisture and contaminants from entering the body.

In another preferred embodiment, there can be a cable splice. The cable splice can include a body having a longitudinal axis along which a first end and a second end of the body taper conically toward the longitudinal axis; a first aperture in the first body end; a second aperture in the second body end; a first set of jaws disposed within the first body end; a second set of jaws disposed within the second body end; a spring within the body, positioned between the first and second set of jaws; and a waterproof gel located at the first end and the second end to prevent moisture from entering the body, whereby preventing internal corrosion.

The cable splice can further include an end funnel located at the first body end and the second body end. The end funnels can include a plurality of finger joints to hold the gel inside the end funnel. The gel can be selected from the group consisting a silicone-based semi-conductive gel, oil-based grease, and wax, wherein the gel can withstand high current and high temperature.

The body of the cable splice can include an end stop, or center stop, fixed in the center of the body perpendicular to the longitudinal axis. A spring mechanism can be located about the center of the body of the cable splice.

A method of installing a conductor into an automatic splice is also described. The method includes providing an automatic splice for connecting two conductors. The automatic splice can include a splice body having a center stop enabling proper conductor insertion depth, wherein the splice body has two opposite ends; a spring-loaded jaw located at the opposite ends of the splice body; an end funnel located at the opposite ends of the splice body enabling insertion of a conductor into the splice body; and a gel housed in the end funnel to protect the automatic splice from deteriorating contaminants. The method can also include the steps of: cutting an end of the conductor square, whereby the conductor is free of burrs; inserting the conductor into the end funnel at one end of the automatic splice; enabling the end of the conductor to reach the center stop of the splice body; and applying a hand tension on the conductor to assure the conductor is fully inserted into the splice body.

These and other objects, features and advantages of the present invention will become more apparent upon reading the following specification in conjunction with the accompanying drawings.

### BRIEF DESCRIPTION OF THE FIGURES

FIG. 1 depicts a side view of an automatic splice in accordance with a preferred embodiment of the present invention.

FIG. 2 depicts a partial cross sectional view of an end funnel in accordance with an embodiment of the present invention.

FIG. 3 depicts a cross sectional view of the end funnel, as taken along AA of FIG. 2.

FIG. 4 depicts another cross section view of the end funnel, as taken along BB of FIG. 2.

FIG. 5 depicts a side view of the automatic splice with conductors to be inserted therein, in accordance with a preferred embodiment of the present invention.

FIG. 6 depicts a cross sectional view of the internal components of the automatic splice, as taken along CC of FIG. 5, before insertion of the conductors.

FIG. 7 depicts a cross sectional view of the internal components of the automatic splice, as taken along CC of FIG. 5, upon insertion of the conductors.

FIG. 8 depicts an exploded view of one end of an automatic splice according to an embodiment of the present invention.

FIG. 9 depicts an automatic splice, according to an embodiment of the present invention, with proper insertion of the conductors.

### DETAILED DESCRIPTION OF THE PREFERRED EMBODIMENTS

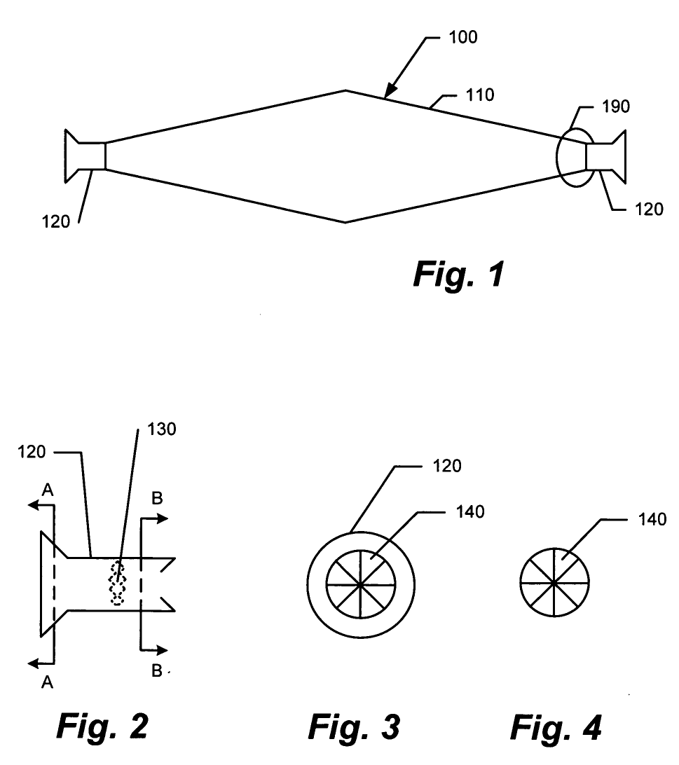

Referring now in detail to the drawing figures, wherein like references represent like parts throughout the several views, FIG. 1 illustrates a preferred embodiment of the present invention an automatic gel splice device.

The present invention, as shown in FIG. 1, is an automatic gel splice or cable splice, which incorporates the use of a waterproof gel at each end of the splice to prevent moisture and contaminants from entering the splice body, and thus to prevent internal corrosion.

The invention comprises an automatic splice 100 having a tapered cylindrical shaped body 110, end funnels 120, and a material 130 located within the end funnels 120. Preferably, the end funnels 120 have 360°, one-way finger joints 140 to hold a high temperature, semi-conductive gel sealant material 130 inside the end funnel 120.

It is known that present automatic splices have limitations. One problem is the corrosion experienced with automatic splices that are installed on lines located in corrosive environments, like the seacoast and heavy industrial areas. Contaminants in the environment enter into a splice body, and over time, they can cause the corrosion of the internal components of the splice. Eventually, the corrosion wears through the splice body of the automatic splice, and this causes the splice to fail.

The present invention overcomes this limitation, wherein the spliced wires pass through the connector, and non-corrosive material, preferably a gel, is used to keep out water or other contaminants from entering the connector. The present invention incorporates gel 130 in a somewhat similar fashion to known submersible connectors for an automatic splice 100, and modifies the end funnel 120 on the automatic splice 100 by having the gel 130 positioned inside the end funnel 120.

The preferable environment of the present invention is the overhead connector, commonly used for overhead electric utility lines. Such lines are typically non-insulated wire, that is, they use the splice 100 for overhead wires that are used on electric utility wires. Lengths of such splices 100 vary, from typically around three (3) inches to thirty-six (36) inches or more, depending on the wire size, because the larger the wire, the longer the connector.

The present automatic splice 100, as depicted in FIG. 1, incorporates a tapered cylindrical body 110, or tube, having a diameter that can range from about one-half (½) inch up to approximately two and one-half (2½) inches, again varying mainly upon the wire size that is used on that splice 100. The cylindrical body 110 can be tapered out towards each end. The automatic splice 100 can be formed from aluminum or copper; alternatively, the splice can be formed from an aluminum alloy or composite, having the mechanical and electrical properties to safely connect overhead wires.

The end diameter of the body 110 of the splice 100 is preferably smaller than the center portion of the body 110, usually close to three-fourths (¾) to one-half (½) of the diameter of the center, which would make it anywhere between one-fourth (¼) of an inch up to about two (2) inches, again depending on the wire size.

The present invention can be sized to accommodate many overhead wires, or conductors, sizes and types, including both aluminum and copper wire. The present splice 100 can be used in many sizes and types of automatic splices for aluminum. For instance, splice 100 can be used for a #4 aluminum ACSR or AAC or AAAC aluminum wire, wherein the automatic splices vary depending on the length of the conductor. Typically, for distribution of a 795 ACSR wire will require a large splice. The automatic splice 100 can be manufactured larger to accomodate a 954 aluminum wire or even a 1033 wire. For copper, the automatic splice 100 would range from a #8 gauge solid copper wire to a 500 MCM copper wire. Even though copper automatic splices do not typically have end funnels, the present invention can comprise a copper automatic splice fitted with gel-filled end funnels in the same manner as in an aluminum automatic splice.

The tapered cylinder body 110, or casing, can include plastic end funnels 120 located at opposite ends of the body 110. The end funnels 120, themselves, taper outwards and can guide the wire, or conductor, properly into the automatic splice 100. Each end funnel 120, preferably, has a taper going outwards. Where the end funnel 120 connects into the splice 100, the diameter of the funnel 120 is similar to the diameter of the splice 100. The end funnel 120 increases to a greater diameter as it extends outwards from the tube 110.

The end funnel 120 can have a beveled edge, and vary in thickness. The present automatic gel splice 100 uses longer length end funnels 120 than are conventionally used, to allow for placement of the gel 130 in the end funnel 120.

The end funnels 120, which are depicted in FIG. 2, include a defined aperture through the middle, enabling the wire inserted therethrough. The end funnels 120 can be made of many materials, but preferably plastic. Alternatively, the funnel 120 can be made of steel, fiberglass, or composite materials including forms of plastic and metal. Moreover, the end funnels 120 can be color-coded to indicate size of the wire suitable for the splice 100.

The end funnels 120 can incorporate 360°, one-way finger joints 140, as depicted in FIGS. 3-4, to hold a high temperature, semi-conductive gel sealant 130 inside the end funnel 120. The finger joints 140 can be made from the same material that would be used for the end funnel 120, but can be of different composition. Preferably, the end funnel 120 and joints 140 are the same material, and made of the same mold in one molded piece, wherein the end funnel 120 and the finger joints 140 are of unitary construction.

The wire passes the finger joints 140 of one end funnel 120, into the gel-filled 130 interior of the end funnel 120, and then passes back through another set of finger joints 140 before it enters into the splice body 110. The fingers 140 are preferably angled inside the hole, toward the gel 130, so that they would be angled inward from each end of the end funnel 120. Alternatively, the fingers 140 can be orientated 90° angles, normal to the wire, or anywhere from 90° inward—the angle would determine the length of the finger joints 140. The finger joints 140 should be long enough where they all would meet in the center of the end funnel 120, and long enough to hold the gel 130 inside the end funnel 140. Preferably, thirteen (13) finger joints 140 form the end of the funnel 120. Depending on the size of the wire, cable or conductor, there can be more or less fingers 140.

The end funnel 120 can, in exemplary embodiments, comprise at least two sets of finger joints 140, a first between the funnel 120 and the outside environment, and a second between the other end of the funnel 120 and the splice body 110. The second set of finger joints 140 can be angled towards the outside of the end funnel 120 going outwards, opposite in orientation to the first set of fingers 140.

The end funnels 120 are secured to the splice body 110 via fitting into the inner diameter of the ends of the splice body 110. The end funnels 120 can be snapped on to the ends of the splice body 110, wherein being pressure fit. The end funnel 120 outer diameter fittingly corresponds to the inner diameter of the splice body 110, so when the two are mated together, they will fit right together and will hold into the splice body 110.

The end funnel 120 can further include a pilot cup, or guide cup 180, that can either be located at the mouth side of the end funnel 120, or it could be located on the splice side of the end funnel 120, which would be the part of the end funnel 120 where the end funnel 120 connects to the splice body 110. If the guide cup 180 is located at the mouth side of the end funnel 120, then as the wire is being inserted, it would first contact the guide cup 180 and then pass through the end funnel 120, which contains the gel 130, and then from there into the splice body 110. If the guide cup 180 is located on the splice side of the end funnel 120, then when the wire is inserted, it would first pass through the end funnel 120 and the gel 130, and then it would engage the guide cup 180 before it entered the splice body 110.

The end of the tapered cylinder body 110 can include a ring 190. A plastic ring 190 can be used, and it can slide down at the end of body 110, held on the tapered cylinder body 110 by the end funnel 120. The ring 190 indicates the size of the wire that can be used for the splice 100. The use of a plastic ring 190 is optional and typically used only on automatic splices that can accommodate multiple wire sizes. In these cases, one wire size is designated by the color of the end funnel and the ring 190 indicates the other wire size(s).

The splice body 110 can further incorporate jaws 150, jaw teeth 155, springs 160 and a center stop 170.

The gel 130 component is preferably located inside the end funnel 120, held in by the sets of finger joints 140 from the outside environment, and the splice body 110. Alternatively, the gel 130 can be located throughout the entire body 110, from end funnel 120 to end funnel 120.

The gel 130 is preferably a silicone-based semi-conductive gel. The gel 130 can be a wax-type material or a grease material, oil-based grease or a wax that can itself be used in place of the gel. The gel 130 can include constituents that change consistency or electrical connectivity. The gel 130 can, preferably, withstand high temperatures, and can have the long life span to be able to shield the splice 100 from the contaminants for many years. Furthermore, the gel 130 can withstand high electrical current applications.

Conventional automatic splices have relatively high failure rates, especially in coastal areas where they are exposed to corrosive environments. When an automatic splice fails, the conductors, which are being spliced together, are released from the splice, and usually fall to the ground. Of course, the splice can fail from overtension or other reasons, not just corrosion. It can fail in either method. Either way it would result in the conductors separating at the splice and the wires falling.

The present invention provides for a splice reducing the risk of failure, as it limits or eliminates corrosion. The conventional automatic splices fail because they experience internal corrosion. Such corrosion causes heavy arching and heating, because of the extra resistance caused by the corrosion. With current trying to pass through the splice with the heavy resistance, it causes the heat and the arching across the corroded areas, and this condition causes splice failure.

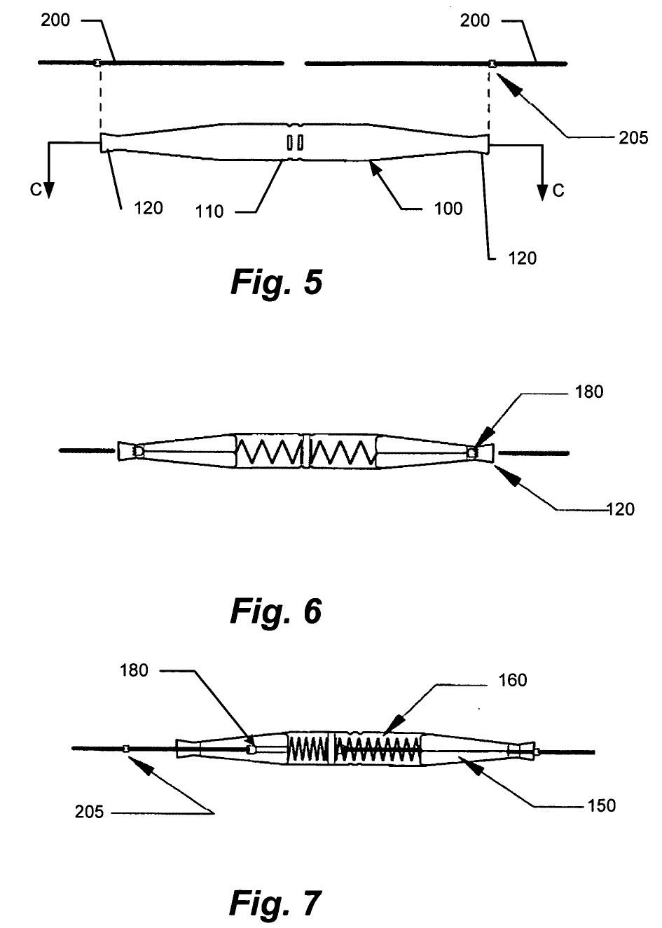

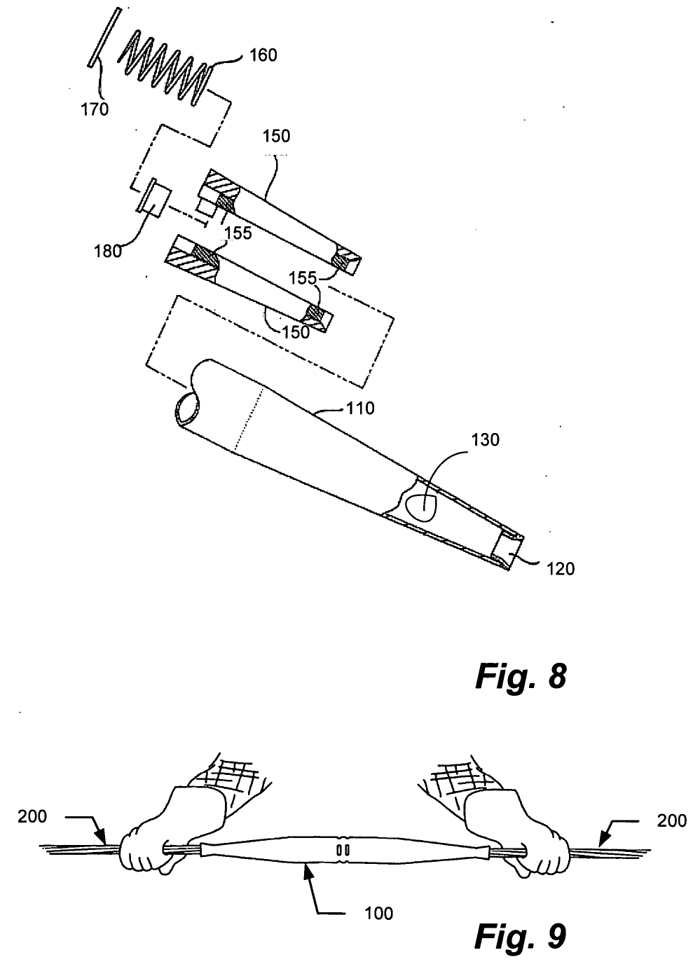

A method of automatic sleeve installation is shown in FIGS. 5-7 and 9, while FIG. 8 shows an exploded view of the automatic gel splice. A conductor or wire 200 is cut square so that all strands are even in lay and free of burrs. The conductor 200 is then straightened to remove curvature.

When repairing or installing the automatic gel splice 100, the conductor 200 is cut back sufficiently to remove stretched, burned, or annealed strands. If tape is used, the tape used to hold the strands together while the conductor is being cut is removed from the ends. The old and new conductors 200 are thoroughly brushed with a steel conductor brush.

The splice body 110 has a center stop 170, fixed perpendicular to the axis of the cylindrically shaped splice 100, to establish the proper conductor insertion depth. The splice body 110 has at least two sets of internal spring-loaded jaws 150—a first set and a second set—located at opposite ends of the body 110. The wedge-shaped jaws 150 are grooved with teeth 155 to grip the conductor 200 tightly under tension. The end funnel 120 improves and simplifies the insertion of the conductor 200 into the body 110. The end funnel 120 further can include a guide cup 180. The splice body 110 can include a pair of springs 160, located on opposite sides of the center stop 170 and further positioned between the first and second set of jaws, to compress the center stop 170 and the jaws 150.

The first steps of installing the conductor 200 in the automatic splice 100 are to measure and mark the conductor 200. The conductor 200 should be placed beside the automatic splice 100. The center stop 170 of the body 110 of the splice 100 should be even with the end of the conductor 200. When the conductor 200 is positioned, the conductor 200 should be marked with a mark 205 outside the end funnel 120.

The conductor 200 is inserted into an aperture end of the splice 100, wherein entering the cylindrical passageway, with a smooth, straight thrust through the jaws 150, until the conductor 200 contacts the center stop 170 of the splice body 110. Preferably, the insertion is one continuous thrust. While inserting the conductor 200, the strands of the conductor 200 enter a guide cup 180 located, near the gel 130, in the end funnel 120. The moving conductor 200 pushes the guide cup 180 against the spring-loaded jaws 150, forcing them toward the center stop 170 inside the body 110. When the guide cup 180 reaches the center stop 170, the jaws 150 can spring back in order to grip the conductor 200. A hand set tension is momentarily applied to assure proper gripping of the jaws 150; see FIG. 9. Consequently, the conductor 200 is fully inserted into the body 110 of the splice 100.

If the conductor 200 is properly installed, the mark 205 placed on the conductor 200 sits just outside the body 110, slightly beyond the end funnel 120. If not, then the conductor 200 is improperly inserted into the splice 100 and will not withstand tension.

Other benefits of the present invention over the known prior art exist. Some of the references disclose methods of splicing that are disadvantageous. Some disclose making the splice by stripping the end of the insulated conductors, and twisting them. Yet, the present invention utilizes no twisting of wires—the splice is made as an automatic splice designed for uninsulated wires.

Further, the present splice 100 can be used on a wide variety of voltage carriers. The operating voltage of the wire 200 could be, for example, a neutral or grounded conductor, which would typically be zero volts in reference to ground or it could be used on high voltage lines and also medium and low voltage lines. As used herein, a low voltage would be anything from zero to 600 volts. A medium voltage would be above 600—above the typical secondary, this would be, for example, in the order of thousands of volts, for example, about 70,000 volts; and high voltage would be 70,000 and above. Known automatic splices typically are not used on the high voltage transmission lines, but the present invention can be used in such an application.

Although the present invention has been described with respect to particular embodiments, it will be apparent to those skilled in the art that modifications to the method of the present invention can be made which are within the scope and spirit of the present invention and its equivalents.

What is claimed is:

1. An automatic splice for connecting two conductors comprising:
a splice body having a center stop enabling proper conductor insertion depth, wherein the splice body has two opposite ends;
a spring-loaded jaw located at the opposite ends of the splice body;
an end funnel located at the opposite ends of the splice body enabling insertion of a conductor into the splice body; and
a gel housed in the end funnel to protect the automatic splice from deteriorating contaminants.

2. The automatic splice of claim 1, wherein the splice body has a tapered cylindrical shape.

3. The automatic splice of claim 1, wherein the end funnel includes a plurality of first finger joints to hold the gel in the end funnel.

4. The automatic splice of claim 3, wherein the end funnel and the finger joints are unitary.

5. The automatic splice of claim 1, further comprising a plurality of second finger joints located within the splice body.

6. The automatic splice of claim 1, wherein the gel is waterproof gel to prevent moisture and contaminants from entering the splice body.

7. A cable splice comprising:
a body having a longitudinal axis along which a first end and a second end of the body taper conically toward the longitudinal axis;
a first aperture in the first body end;
a second aperture in the second body end;
a first set of jaws disposed within the first body end;
a second set of jaws disposed within the second body end;
a spring within the body, positioned between the first and second set of jaws; and
a waterproof gel located at the first end and the second end to prevent moisture from entering the body, whereby preventing internal corrosion.

8. The cable splice of claim 7, further comprising an end funnel located at the first body end and the second body end.

9. The cable splice of claim 8, wherein the end funnels include a plurality of finger joints to hold the gel inside the end funnel.

10. The cable splice of claim 7, wherein the gel is selected from the group consisting a silicone-based semi-conductive gel, oil-based grease, and wax, wherein the gel can withstand high current and high temperature.

11. The cable splice of claim 7, wherein the body includes an end stop fixed in the center of the body perpendicular to the longitudinal axis.

12. The cable splice of claim 7, further comprising a spring mechanism located about the center of the body.

13. A method of installing a conductor into an automatic splice, the method comprising:
providing an automatic splice for connecting two conductors, the automatic splice including:
a splice body having a center stop enabling proper conductor insertion depth, wherein the splice body has two opposite ends;
a spring-loaded jaw located at the opposite ends of the splice body;
an end funnel located at the opposite ends of the splice body enabling insertion of a conductor into the splice body; and
a gel housed in the end funnel to protect the automatic splice from deteriorating contaminants;
cutting an end of the conductor square, whereby the conductor is free of burrs;
inserting the conductor into the end funnel at one end of the automatic splice;
enabling the end of the conductor to reach the center stop of the splice body; and
applying a hand tension on the conductor to assure the conductor is fully inserted into the splice body.

14. The method of installing the conductor of claim 13, wherein the conductor is a high voltage conductor.
